(19) United States
(12) Patent Application Publication
(10) Pub. No.: US 2004/0042618 A1
(43) Pub. Date: Mar. 4, 2004

(54) Battery structure for a cellular phone

(76) Inventor: Ming-Shiou Ho, Kaohsiung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/229,091

(22) Filed: Aug. 28, 2002

(51) Int. Cl. H04M 1/00; H04M 9/00

(52) U.S. Cl. 379/428.01

(57) ABSTRACT

A battery structure for a cellular phone essentially includes a housing and a battery, wherein, the housing is formed corresponding to the size of a space available for the battery inside the cellular phone and an accommodation space is provided in the housing to receive the battery so that the battery may be directly mounted to the cellular phone or together with the housing when adaptation to a cellular phone of different size is required.

### BACKGROUND OF THE INVENTION

(a) Field of the Invention

The present invention relates to a battery structure of a cellular phone, and more particularly, to one that is adaptable to any model of different brands.

(b) Description of the Prior Art

As the living standard has been continuously upgraded thanks to advanced development of technology, use of digital camera, cellular phone, TV game player, camcorder, Two-Way radio, cordless phone, or notebook computer is significantly increased. Among all the electronic products, the cellular phone is most frequently used as it provides to the general public a very convenient communication means. There are many models from different brands of cellular phone generally available in the market, and all models have to rely upon rechargeable battery as the power source. So far, the rechargeable battery is mounted to the cellular phone either by having the battery formed as the back cover of the cellular phone and directly inserted to the back of the cellular phone, or by having the battery formed in a rectangular block and made available in larger and smaller sizes depending on the individual model of the cellular phone. In either size, the battery is placed inside the cellular phone and closed up with a back cover in relation to the body of the cellular phone to build the battery in the cellular phone.

For the battery integrated with the cellular phone, it is formed in relation to the style of the cellular phone. A consumer has to purchase only the spare battery for that particular model of cellular phone and no other type of battery can be used. Thus, the battery is supplied in limited quantity and has a very narrow range of applicability.

As for the battery built in the cellular phone, the battery is formed in relation to the size of the cellular phone. Any type of battery can be used for the cellular phone as long as the battery can be fitted in the cellular phone. This type of battery gives wider range of applicability. It can be adapted to any model even from different brands.

However, such battery though being applicable to most of models of the cellular phone, the battery itself is available in size and thickness. The selection of the size of the battery depends on that of the cellular phone. Therefore, as it is not unusable for a consumer to have two cellular phones, he or she has to always prepare four units of battery (one in use plus a spare for each unit of the cellular phone).

### SUMMARY OF THE INVENTION

The primary purpose of the present invention is to provide a universal battery structure that can be adapted to cellular phones of all models manufactured by different companies. To achieve the purpose, a single unit of battery is adapted to a housing of a battery, then mounted to a cellular phone, essentially composed of the housing and the battery, characterized by that: the housing is formed corresponding to a space in the cellular phone made available to contain a battery, and an accommodation space is provided in the housing while the battery is formed corresponding to the accommodation space merely for the battery to be inserted into the accommodation space; so that the battery may be either directly mounted to the cellular phone with or without the housing when adaptation to another model of different size.

The invention can be applied to the battery structure not only for cellular phone, but also for digital camera, camcorder, Two-Way radio, cordless phone, notebook computer, TV game player . . . etc.

### BRIEF DESCRIPTION OF THE DRAWINGS

FIG. 1 is an exploded view of a preferred embodiment of the present invention.

FIG. 2 is a perspective view showing an assembly of the preferred embodiment of the present invention.

FIG. 3 is a cross-sectional showing that the preferred embodiment of the present invention is in practical use.

FIG. 4 is an exploded showing another preferred embodiment of the present invention.

FIG. 5 is a cross-sectional view of an assembly of another preferred embodiment of the present invention.

### DETAILED DESCRIPTION OF THE PREFERRED EMBODIMENTS

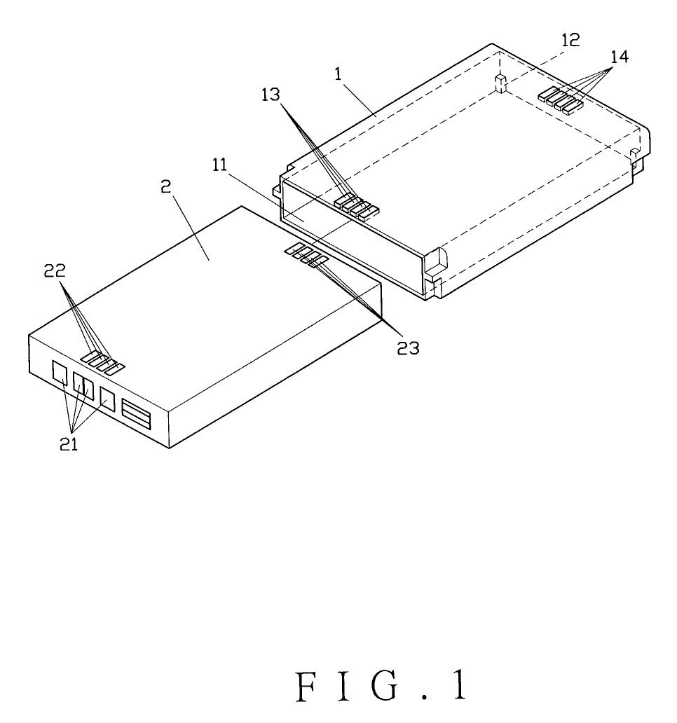

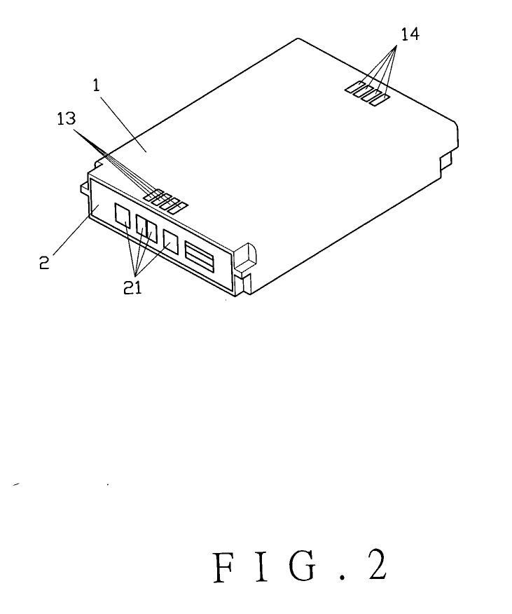

Referring to FIGS. 1 and 2, a preferred embodiment of the present invention essentially comprises a housing (1) and a battery (2).

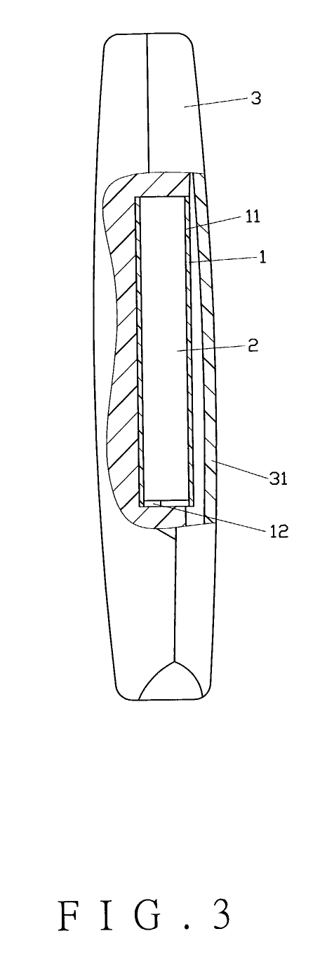

The housing (1) is formed corresponding to a space in a cellular phone of the genuine maker (refer to FIG. 3) made available to place a battery. In the first preferred embodiment, the housing (1) is formed corresponding to the interior space of the cellular phone (3); an accommodation space (11) is made available in the housing (1) to receive the battery (2); both sides at one end of the accommodation space (1) are respectively formed with a stop (12); two groups of conductive plates (13, 14) are provided on the housing (1) relative to conductive terminals on the cellular.

The battery (2) is formed corresponding to the size of the accommodation space (11) of the housing (1) so that the battery (2) is merely inserted into the accommodation space (11), and two groups of conductive plates (22, 23) are formed on the battery (2) and conductive plates (21) are formed at one end of the battery (2) relative to the conductive terminals located on the cellular. The conductive plates (22, 23) can relatively contact with the conductive plates (13, 14) of the housing (1).

Accordingly, the battery (2) can be adapted to a cellular phone in different sizes. Wherein, if a smaller size of battery is used, the battery (2) is directly mounted to the cellular phone (3), and then mounted to a back cover (31) of the cellular phone (3). If a larger size of battery is used, the battery (2) is first inserted and secured in the accommodation space (11) of the housing (1) with the stops (12) in the accommodation space (11) of the housing (1) to restrict the battery (2) in position, then the battery (2) together with the housing (1) is mounted to the cellular phone (3). Finally, the size of the housing (1) merely fills up a space between the battery (2) and the cellular phone (3).

Furthermore, as the conductive plates (13, 14, 22, 23) are provided respectively on the surface of the housing (1) and the battery (2), the battery (2) can be applied to the cellular phone (3) operating on a smaller or a larger size of battery by taking advantage of the conductive plates (13, 14, 22, 23) are provided respectively on the surface of the housing (1) and the battery (2).

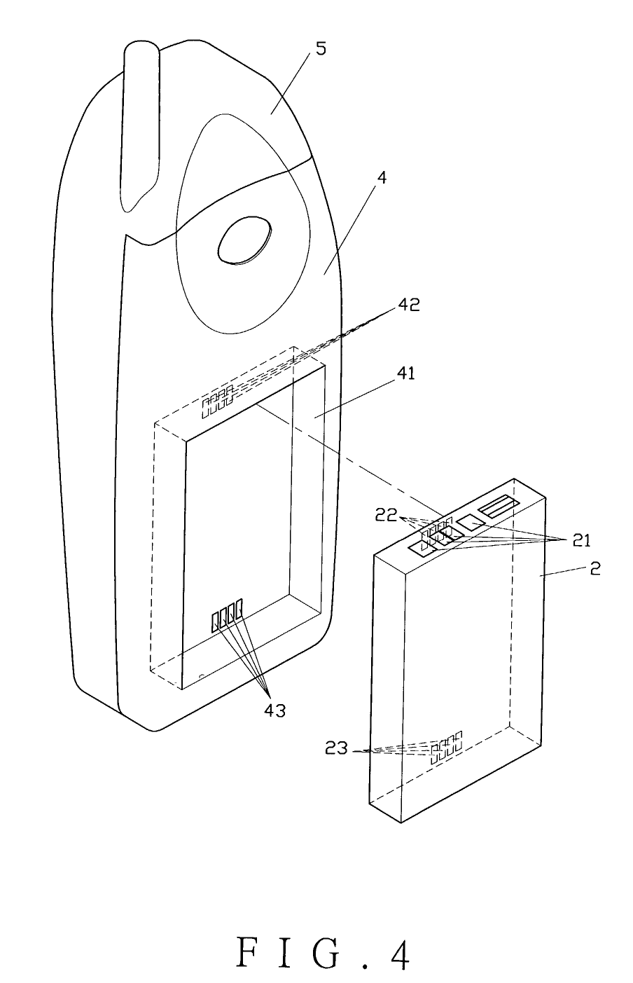

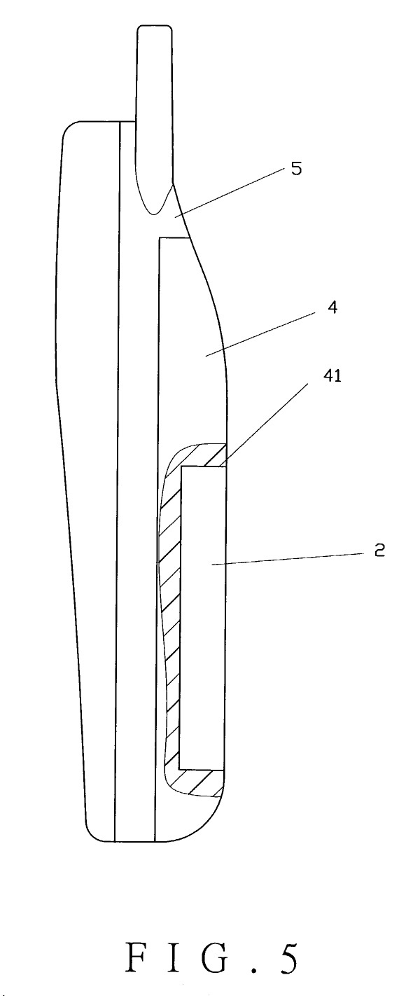

Now referring to FIGS. 4 and 5, a housing (4) of the present invention is formed adaptable to a cellular phone of different brand. Wherein, an accommodation space (41) corresponding to the size of the battery (2) is provided in the housing (4) so that the battery (2) is directly received in the accommodation space (41) of the housing (4) while two group of conductive plates (22, 23) are respectively provided to contact two groups of conductive plates (42, 43). Consequently, the battery (2), together with the housing (4), is mounted to the body of a cellular phone (5).

The housing (1, or 4) varies depending on the model of the cellular phone among different brands while the battery (2) can be made in a constant type that adapts the same to different housings (1, 4) to be respectively used in cellular phones (3, 5) of different models.

It is to be noted that the same teaching for the battery of the present invention disclosed above can be applied to a battery unit attached to a digital camera, a recorder camera, a TV game player and a notebook computer, and a single unit of the battery of the present invention can be also applied to various types of electronic products.

The present invention offers an improved structure for a battery of a cellular phone by having a housing to become interchangeable between larger and smaller size of batteries to provide a universal battery adaptable to a cellular phone of different models.

I claim:

1. A battery structure for a cellular phone comprising a housing and a battery, wherein,
the housing is formed corresponding to the size of a space available for the battery inside the cellular phone and an accommodation space is provided in the housing to receive the battery so that the battery may be directly mounted to the cellular phone or with the housing when adaptation to a cellular phone of different size is required.

2. A battery structure for a cellular phone as claimed in claim 1, wherein, conductive plates are provided respectively on the housing and on the battery in relation to conductive terminals of the cellular phone.
